(19) United States
(12) Patent Application Publication
(10) Pub. No.: US 2017/0159953 A1
(43) Pub. Date: Jun. 8, 2017

(54) AIR CONDITIONER AND METHOD FOR CONTROLLING AN AIR CONDITIONER

(71) Applicant: LG ELECTRONICS INC., Seoul (KR)

(72) Inventors: Jusu KIM, Seoul (KR); Juyoun LEE, Seoul (KR); Beungyong PARK, Seoul (KR)

(73) Assignee: LG ELECTRONICS INC.

(21) Appl. No.: 15/345,598

(22) Filed: Nov. 8, 2016

(30) Foreign Application Priority Data
Dec. 4, 2015 (KR) 10-2015-0172071

(51) Int. Cl. F24F 11/00; G05D 23/19; G05B 19/048

(52) U.S. Cl. CPC F24F 11/006; F24F 11/0034; F24F 11/0015; F24F 11/0078; F24F 11/0079; G05B 19/048; G05D 23/1917; F24F 2011/0061; F24F 2011/0063; F24F 2011/0038; F24F 2011/0064; F24F 2011/0075; F24F 2011/0073; F24F 2011/0083; G05B 2219/2614

(57) ABSTRACT

An air conditioner and a method for controlling an air conditioner are provided. The method for controlling an air conditioner may include determining a user set temperature and performing an air cooling operation or an air heating operation in an indoor space; determining whether a user is present in the indoor space; when it is determined that the user is absent from the indoor space, counting an elapsed time; and when the elapsed time reaches a set time, performing a predetermined operation mode.

### CROSS-REFERENCE TO RELATED APPLICATION(S)

The present application claims priority under 35 U.S.C. 119 and 35 U.S.C. 365 to Korean Patent Application No. 10-2015-0172071, filed in Korea on Dec. 4, 2015, which is hereby incorporated by reference in its entirety.

### BACKGROUND

1. Field

Air conditioner and a method for controlling an air conditioner are disclosed herein.

2. Background

Air conditioners are electronic appliances that maintain air in a predetermined space in a most suitable state according to uses and purposes. Generally, an air conditioner includes a compressor, a condenser, an expansion device, and an evaporator, and drives a refrigeration cycle in which compression, condensation, expansion, and evaporation processes of a refrigerant are performed to cool or heat the predetermined space.

The predetermined space may be various spaces depending on a place in which the air conditioner is to be used. For example, when the air conditioner is located in a home or office, the predetermined space may be an indoor space of a house or building.

When the air conditioner performs an air cooling operation, an outdoor heat exchanger provided in an outdoor unit or device functions as a condenser and an indoor heat exchanger provided in an indoor unit or device functions as an evaporator. On the other hand, when the air conditioner performs an air heating operation, the indoor heat exchanger functions as a condenser and the outdoor heat exchanger functions as an evaporator. The air conditioner needs to operate in an appropriate manner so as to make a user feel comfortable, for example, not too hot or too cold.

The air conditioner is one of electric appliances with relatively high power consumption. Recently, technology has been developed to improve an operation efficiency of the air conditioner in order to reduce power consumption in the air conditioner.

For example, there has been suggested a method of sensing whether a user is present in an indoor space in which an air conditioner is mounted and controlling operation of the air conditioner based on a sensing result. A related art document relating to the above-described control method is Korean Application No. 10-2008-0132435, filed in Korea on Dec. 23, 2008 and entitled “Air Conditioner and Control Method therefor”, which is hereby incorporated by reference.

According to the above related art, there is provided only technology to control cold air or hot air to be a direct air flow or indirect air flow depending on whether a user is present/absent, or technology to calibrate an indoor space by calibrating a set air conditioning temperature. Further, there is no description of a method of controlling operation of an air conditioner based on a period of time during which the user is absent.

There may be a case in which a plurality of users frequently come into and leave an indoor space, for example, an office, a church, a meeting room, or an unmanned store, or even a case in which a user is absent. However, even in this case, the air conditioner continuously operates under a predetermined condition, thus causing unnecessary energy consumption (spatial inefficient operation). In addition, in a case in which a user is absent for a relatively long period of time during a specific time period, for example, a lunch time, a break time, or a school arriving or leaving time, for example, unnecessary energy consumption may further increase (temporal inefficient operation).

### BRIEF DESCRIPTION OF THE DRAWINGS

Embodiments will be described in detail with reference to the following drawings in which like reference numerals refer to like elements, and wherein:

FIGS. 1A to 1C are schematic diagrams respectively showing control states of an air conditioner when a user is present in an indoor space, when a user is absent from an indoor space, and when a user is entering an indoor space after being absent;

FIG. 2 is a block diagram of an air conditioner according to an embodiment;

FIGS. 3 to 5 are flowcharts of a method for controlling an air conditioner, according to an embodiment;

FIGS. 6A and 6B are graphs showing changes in temperature of an indoor space and a PMV index in an air heating operation and an air cooling operation of an air conditioner; and

FIG. 7 is a graph showing changes in PMV index and power consumption in a case of controlling the air cooling operation of an air conditioner according to an embodiment.

### DETAILED DESCRIPTION

Hereinafter, specific embodiments will be described with reference to accompanying drawings. It will be understood that the description herein is not intended to limit the claims to the specific embodiments described. On the contrary, it is intended to cover alternatives, modifications, and equivalents as may be included within the spirit and scope of the present disclosure as defined by the appended claims.

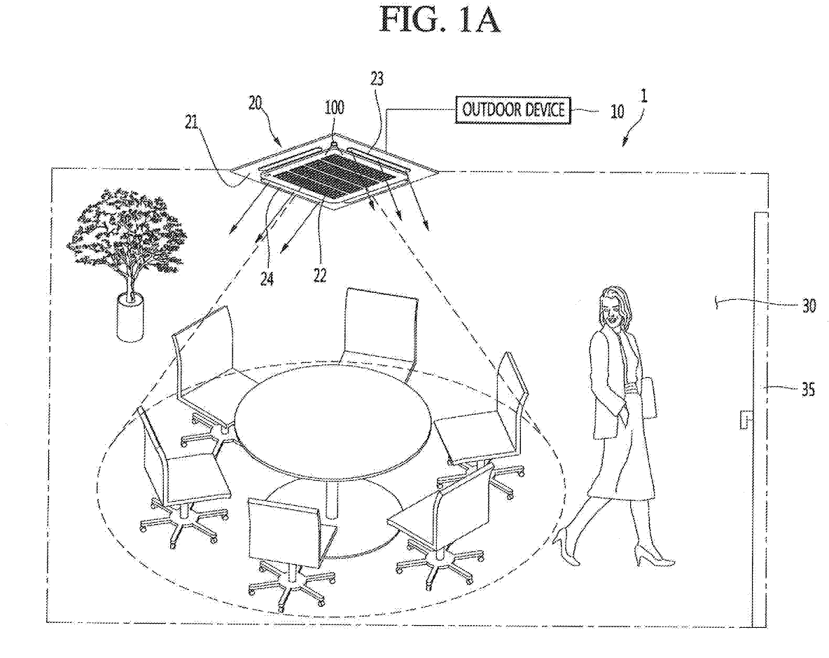

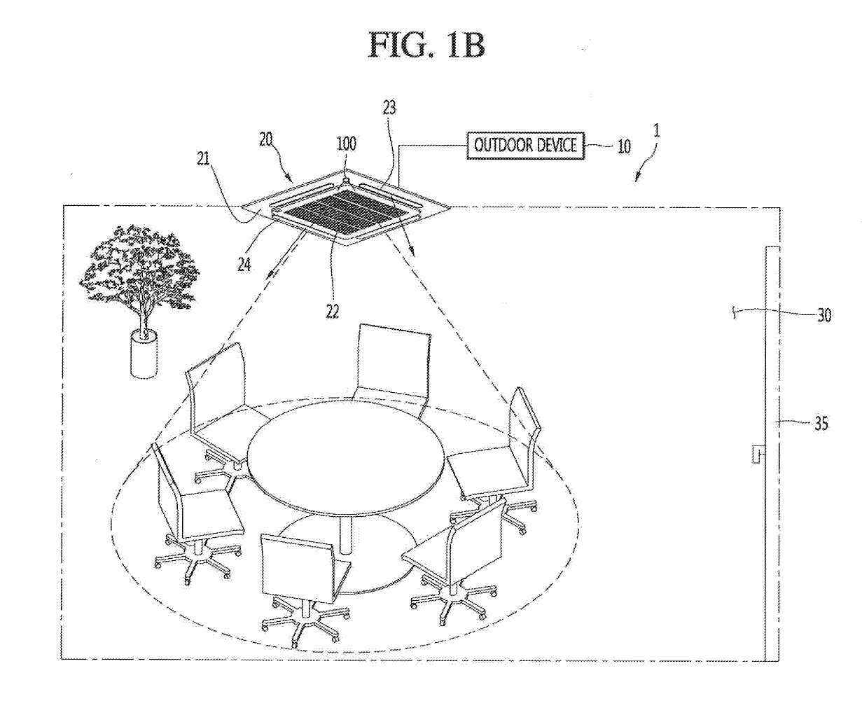

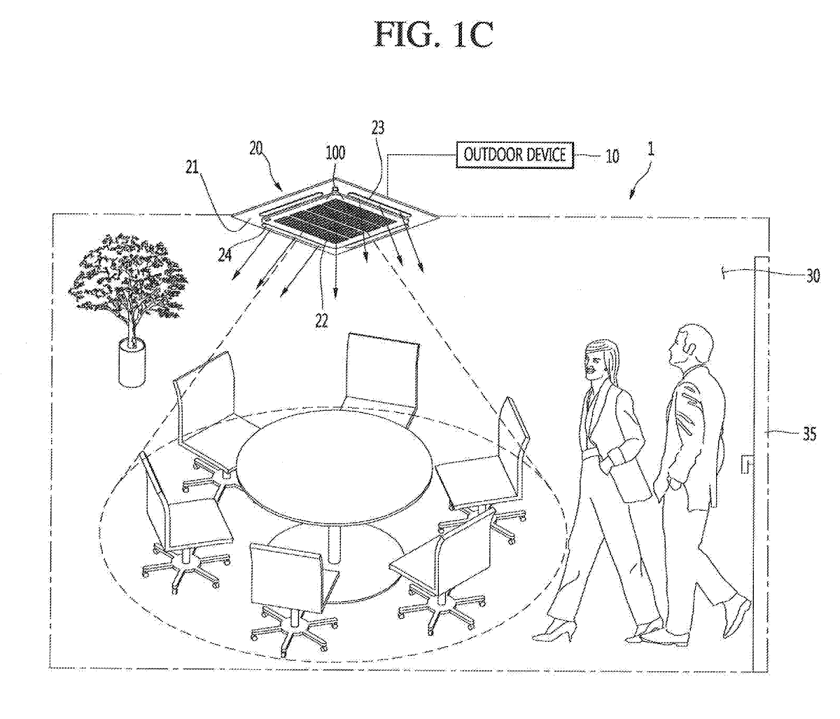

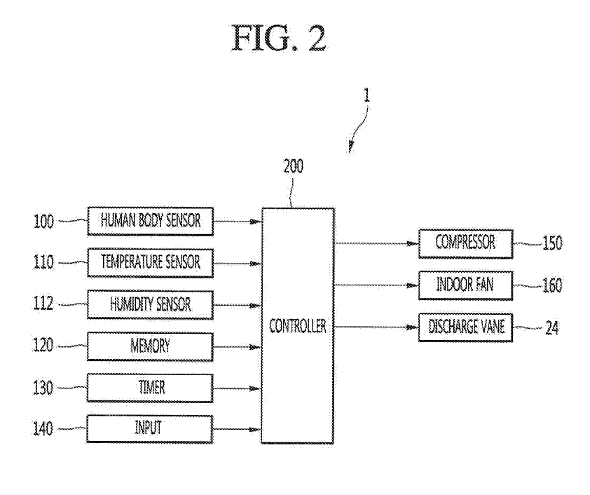

FIGS. 1A to 1C are schematic diagrams respectively showing control states of an air conditioner when a user is present in an indoor space, when a user is absent from an indoor space, and when a user is entering an indoor space after being absent. Referring to FIGS. 1A to 1C, an indoor unit or device 20 may be mounted within an indoor space 30 in which a user lives or works, for example. The indoor device 20 is an element of an air conditioner 1 and may be operatively connected to an outdoor unit or device 10. The outdoor device 10 may be mounted outside of the indoor space 30, for example, outside of a building and may include a compressor 150 (see FIG. 2).

Although the indoor device 20 is illustrated as a ceiling type indoor unit or device mounted in the ceiling, in FIGS. 1A to 1C, the indoor device 20 may be configured to be mounted in a wall (wall type indoor unit or device), or to stand on the floor (stand type indoor unit or device). The following description will be given by taking, as an example, a case in which the indoor device 20 is a ceiling type indoor unit.

The indoor device 20 may include a front panel 21 that defines a bottom of the indoor device 20, a suction portion or inlet 22 formed in the front panel 21 to suction air in the indoor space 30, and one or more discharge portion or outlet 23 through which air which is heat-exchanged may be discharged. An indoor heat exchanger and an indoor fan 160 (see FIG. 2) that generates an airflow may be mounted inside of the indoor device 20. Also, the indoor device 20 may further include one or more discharge vane 24 movably provided at one side of each discharge outlet 23 to adjust a volume of air discharged from the discharge outlet 23. The discharge vane 24 may increase or decrease an opening degree of the discharge outlet 23.

For example, when a number of rotations of the indoor fan 160 is high or an opening degree of the discharge vane 24 is increased, the volume of air discharged from the indoor device 20 may increase. On the other hand, when the number of rotations of the indoor fan 160 is low or the opening degree of the discharge vane 24 is decreased, the volume of air discharged from the indoor device 20 may decrease.

The indoor device 20 further include a human body sensing unit or sensor 100 capable of sensing whether a user is present in the indoor space 30. For example, the human body sensor 100 may be mounted in the front panel 21 to be arranged directed toward the indoor space 30.

For example, the human body sensor 100 may include a vision sensor capable of sensing an image of a human body. The vision sensor may be a sensor capable of acquiring an image of a predetermined object existing or located in the indoor space 30. The image acquired by the vision sensor may be compared with a previously-stored image and it may be determined whether the object is a human being.

As another example, the human body sensor 100 may include a pyroelectric infrared (PIR) sensor capable of sensing a motion of a human body. The PIR sensor may sense a change in infrared rays emitted from a human body and the sensed information may be used to determine whether the user is present in the indoor space 30.

FIG. 1A illustrates a state in which the indoor device 20 operates under operation conditions set by a user when the user is present in the indoor space 30. FIG. 1B illustrates a state in which a “comfort power saving mode” is performed when the user opens a door 35 and leaves the indoor space 30.

The comfort power saving mode is a mode performed when the user is absent from the indoor space, and may be a mode performed under an operation condition for allowing a reduction in power consumption by making a comparison of operation conditions set by the user. For example, when the comfort power saving mode is performed during an air cooling operation of the air conditioner 1, a set temperature of the indoor space 30 may be determined to be higher than a temperature set by the user. On the other hand, when the comfort power saving mode is performed during an air heating operation of the air conditioner 1, a set temperature of the indoor space 30 may be determined to be lower than a temperature set by the user.

It is noted that, although the power saving mode is performed, it may be necessary to keep the indoor space 30 comfortable for the comfort feeling of the user. A comfort operation of the air conditioner 1 according to this embodiment may include a control operation using a Predicted Mean Vote (PMV) index.

The PMV refers to a predicted thermal comfort and may be understood as an index of a thermal environment, which is determined to quantitatively express the effect of complex factors of the thermal environment on a human body and simply and exactly provide a range of a comfortable thermal environment. More specifically, the PMV is an index obtained by theoretically predicting a human thermal comfort in such a way as to measure an air temperature, a relative humidity, a radiant temperature, an air speed, clothing insulation, and metabolic rates, which are six factors of the thermal environment in a human being and an ambient environment, and substitute the measurements to a comfort equation based on a heat balance of a human body.

The PMV may be calculated as a function of the six elements of the thermal environment. In order to perform the power saving mode of the air conditioner 1, and at the same time, achieve the comfortable indoor space 30, control may be performed to increase values of other elements, rather than reduce a value of an element directly related to power consumption.

The PMV may be determined within a range of index values which are classified according to a seven point scale as shown in [Table 1] below.

TABLE 1

| PMV | +3 | +2 | +1 | 0 | −1 | −2 | −3 |
|---|---|---|---|---|---|---|---|
| Comfort | Hot | Warm | Slightly | Neutral | Slightly | Cool | Cold |
| degree | | | warm | | cool | | |

More specifically, as shown in [Table 1], as a PMV index value is close to +3, the thermal perception is “hot” and as a PMV index value is close to −3, the thermal perception is “cold”. A range where a user can feel comfortable may be determined to be a range from +1 to −1. The air conditioner 1 according to this embodiment may control a comfort degree of the indoor space 30 such that the PMV index value has a value from +1 to −1.

Also, a predicted percentage of dissatisfied (PPD) may be defined. The PPD represents a percentage of persons who will be dissatisfied with a current environment based on a seven point scale of the PMV. The PPD is a function of the PMV, and when the PMV is determined, may be determined to be a specific value.

For example, when the PMV index value has a value between +1 and −1, the PPD may be expressed as a relatively low value, that is, a value at which most people feel comfortable. In this embodiment, when it is recognized that the user is absent from the indoor space 30, the comfort power saving operation may be performed such that the PMV index value has a value between +1 and −1.

In a case of the air conditioner 1 according to this embodiment, in order to simplify the control method, a clothing insulation and metabolic rate of the six factors of the thermal environment may have predetermined reference values. On the other hand, the temperature, the humidity (relative humidity), and the mean radiant temperature may be determined, respectively, by measuring an indoor temperature and an indoor humidity. In this case, the temperature and the mean radiant temperature may be determined to be a same value. Further, the air speed may be determined based on a rotation speed of the indoor fan 160.

In the case of FIG. 1B, when the user is absent from the indoor space 30, the set temperature of the indoor space 30 may be determined to be lower than the temperature set by the user. That is, the set temperature of the indoor space 30 may be determined to increase in the air cooling operation and decrease in the air heating operation. By performing the above determination, power consumption may be reduced.

The temperature and the relative humidity may be changed due to a change in the set temperature, and therefore, the PMV index value may be changed. Although the PMV index value is changed, another factor, for example, the air speed may be controlled such that the index value does not go out of a comfort range.

By performing the above control method, the indoor space 30 may be maintained at a minimum comfort degree even when the user is absent from the indoor space 30. Therefore, when the user returns to the indoor space 30 after a predetermined time has elapsed as in FIG. 1C, the user may experience a relatively high comfort feeling.

FIG. 2 is a block diagram of an air conditioner according to an embodiment. Referring to FIG. 2, the air conditioner 1 according to an embodiment may include human body sensor 100 configured to sense whether a user is present in the indoor space 30, and a temperature sensor 110 and a humidity sensor 112 configured to sense a temperature and a humidity in the indoor space 30, respectively. For example, the human body sensor 100, the temperature sensor 110, and the humidity sensor 112 may be provided in the indoor device 20.

The air conditioner 1 may further include a memory unit or memory 120 configured to store necessary information for operation of the air conditioner 1. More specifically, the memory 120 may store information about preset or predetermined factor values, for example, preset or predetermined reference values for the clothing insulation and the metabolic rates, in order to calculate the PMV.

The memory 120 may store referee image information which may be compared with image information recognized by the human body sensor 100. More specifically, the human body sensor 100 may include a vision sensor. An image sensed by the vision sensor may be compared with information about a person image stored in the memory 120, and when the image is identical to the person image entirely or partly in a set ratio or more, it may be recognized that the user is present in the indoor space 30.

The air conditioner 1 may further include a timer 130 that measures elapsed time from a time point at which it is recognized that the user is absent from the Indoor space 30 in order to perform a comfort power saving operation. The time counted by the timer 130 may be compared with predetermined first to third set times. A comparison result may be used as control information for operation of the air conditioner 1.

The air conditioner 1 may further include an input unit or input 140 configured to allow a user to input predetermined information for operation of the air conditioner 1. The input 140 may include a power input unit or input configured to turn on or off the power supply of the air conditioner 1 and a set temperature input unit or input configured to receive a set temperature of the indoor space 30.

The air conditioner 1 may further include a control unit or controller 200 electrically connected to the human body sensor 100, the temperature sensor 110, the humidity sensor 112, the memory 120, the timer 130, and the input 140 to control operations of the compressor 150, the indoor fan 160, and the discharge vane 24, based on information recognized from the components. More specifically, the controller 200 may control an operating frequency or duty rate of the compressor 150 based on a set temperature input from the input 140 or a set temperature separately determined in a comfort power saving operation.

For example, when a temperature difference value between the set temperature and the current temperature of the indoor space 30 is large, it is possible to increase an operating frequency or duty rate of the compressor 150. On the other hand, when a temperature difference value between the set temperature and the current temperature of the indoor space 30 is small, it is possible to decrease the operating frequency or duty rate of the compressor 150.

The controller 200 may control a number of rotations of the indoor fan 160 or an opening degree of the discharge vane 24, which enables control of the air speed of the six factors of the thermal environment, in order to control a PMV index value. In addition, the controller 200 may calculate a value of the air speed based on information about the number of rotations of the indoor fan 160 or the opening degree of the discharge vane 24.

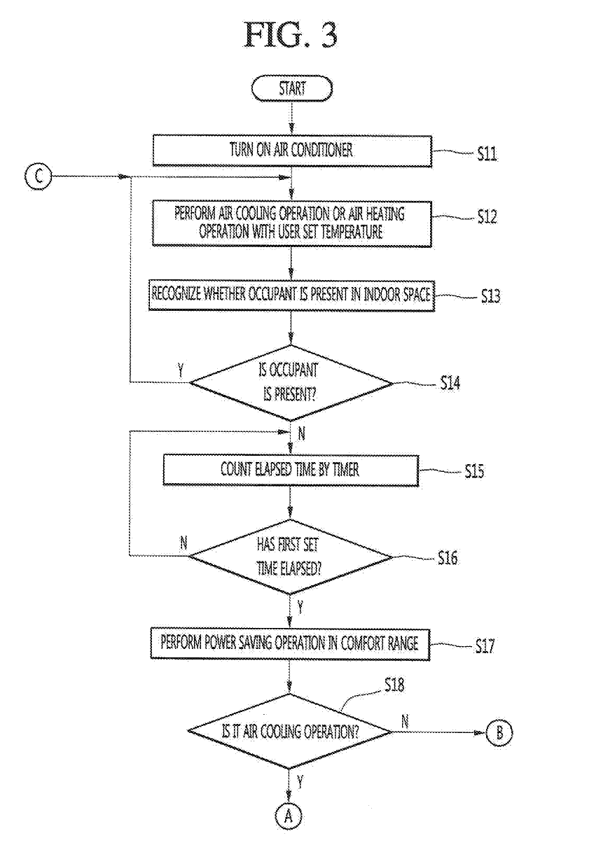

FIGS. 3 to 5 are flowcharts of a method of controlling an air conditioner according to an embodiment. Referring to FIGS. 3 to 5, a method for controlling an air conditioner according to an embodiment will be described hereinafter.

A user may turn on a power supply of an air conditioner, such as air conditioner 1 of FIGS. 1A-2, and input information about a set temperature of an indoor space, such as indoor space 30, by manipulating an Input, such as input 140 (S11). The set temperature input by the user may be referred to as a “user set temperature”. The air conditioner may perform a cooling or air heating operation based on the user set temperature (S12).

The method may be recognized whether a user (occupant) is present in the indoor space through a human body sensor, such as human body sensor 100 (S13 and S14). When it is recognized that a user is present in the indoor space, operation of the air conditioner may be controlled according to information set by the user, that is, the user set temperature. On the other hand, when it is recognized that the user is absent from the indoor space, a time elapsed therefrom may be counted by a timer, such as timer 130 (S15). While the time is being counted, the operation of the air conditioner may be controlled according to the user set temperature.

Whether the counted time has reached a first set time may be recognized (S16). The first set time may be a period of time long enough to recognize that the user is absent from the indoor space for a relatively long time and may be previously determined and stored in a memory, such as memory 120. For example, the first set time may be 30 minutes.

When the counted time has reached the first set time, a “comfort power saving operation” for reduction in power consumption may be performed (S17). The comfort power saving operation may be an operation for reducing power consumption while maintaining a predetermined range of a comfort degree in the indoor space and increasing a power saving level in a stepwise manner as time elapses.

When the comfort power saving operation is initiated, whether the operation mode of the air conditioner is the air cooling operation or the air heating operation may be determined (S18). When the operation mode of the air conditioner is the air cooling operation, a set comfort temperature may be determined according to the “user set temperature” set by the user (S19). The set comfort temperature may be another set temperature of the indoor space, which is a control reference for the comfort power saving operation. In other words, the set comfort temperature may be a predetermined temperature value in order for a required comfort degree of the indoor space, that is, the PMV index value to be in a range from −1 to +1.

More specifically, when the user set temperature is lower than a first temperature value A (S20), the set comfort temperature may be determined to be the first temperature value A (S21). That is, the set comfort temperature may be determined to be higher than the temperature set by the user. For example, the first temperature value may be 26° C. In addition, an air volume in a comfort range, which is matched with the set comfort temperature A may be controlled (S22).

Due to the above control, the indoor space may be controlled such that the required comfort degree, that is, the PMV index value is in the range from −1 to +1. The set comfort temperature A may be a factor that influences the temperature, humidity, and mean radiant temperature of the indoor space, and the air volume in the comfort range may be a factor that influences the air speed.

During control using the set comfort temperature A and the air volume in the comfort range, the temperature, humidity, and mean radiant temperature of the indoor space and the air speed may be measured in real time. As described above, the clothing insulation and the metabolic rate of the six factors of the thermal environment may be previously determined to be set values.

The PMV index value may be monitored through the measured values and the set values and control may be performed such that the PMV index value is in a set range (from −1 to +1). For example, as a factor causing relatively large power consumption in the operation of the air conditioner is a set temperature, the PMV index value may be controlled so as to be a required value by maintaining the set temperature at the first temperature value A and controlling the air speed through the control of the number of rotations of an indoor fan, such as indoor fan 160.

In the process of controlling the comfort power saving operation, whether a second set time has elapsed may be recognized (S23). The second set time may be a time counted from a time point when the first set time has elapsed. For example, the second set time may be about 20 minutes.

When the second set time has elapsed, control may be performed to increase the power saving level of the comfort power saving operation (S24). More specifically, it is possible to perform control to increase the comfort set temperature. That is, it is possible to increase the comfort power saving temperature from the first temperature value A to a second temperature value B (S25). The second temperature value B may be higher than the first temperature value A, and may be, for example, 28° C. In addition, an air volume in a comfort range, which is matched with the set comfort temperature B, may be controlled (S26).

In the process of performing control, the PMV index value may be controlled to be in a required range (−1 to +1), and therefore, a minimum comfort degree of the indoor space may be maintained. Further, as the power saving level higher than the power saving level of the power saving operation performed in S22 may be maintained in S26, power consumption may be reduced.

Following the process of performing the control of S24 to S26, whether a third set time has elapsed may be determined (S27). The third set time may be a time counted from a time point when the second set time has elapsed. For example, the third set time may be about 10 minutes.

When the third set time has elapsed, it may be determined that the user is absent for a long time, and operation of the air conditioner may be turned off (S28). The second set time may be determined to be shorter than the first set time, and the third set time may be may be determined to be shorter than the second set time. As a time for which the user is absent in the indoor space increases, it is predicted that a possibility that the user does not enter the indoor space for a while is high, and by advancing a time at which increasing the power saving level is performed, it is possible to prevent air conditioning from being performed unnecessarily excessively in the indoor space in which the user is absent. Accordingly, power consumption may be reduced.

On the other hand, when it is recognized that the second set time has not elapsed in S23, it may be determined whether the user (occupant) is present in the indoor space. When the user is absent, subsequent steps or operations from step S21 may be performed. When the user is present, subsequent steps or operations from step S12 may be performed (S29).

Further, when it is recognized that the third set time has not elapsed in S27, it may be determined whether the user (occupant) is present in the indoor space. When the user is absent, subsequent steps or operations from step S25 may be performed. When the user is present, subsequent steps or operations from step S12 may be performed (S30).

On the other hand, when the user set temperature is equal to or higher than the first temperature value A (S31), which is lower than the second temperature value B, the set comfort temperature may be determined to be the second temperature value B (S32). That is, in S25, determining the set comfort temperature to be the second temperature value B may be performed after the second set time has elapsed, whereas, in S31, determining the set comfort temperature to be the second temperature value B may be performed simultaneously with initiation of the comfort power saving operation. The reason for this may be understood as a result of determination as to whether a comfort degree of the indoor space is high or low depending on a preference of the user, that is, the user set temperature. That is, when the user set temperature is relatively low, the set comfort temperature may be slowly increased, whereas, when the user set temperature is relatively high, the set comfort temperature may be rapidly increased (S32). In addition, an air volume in a comfort range, which is matched with the set comfort temperature B may be controlled (S33). Due to the above control, the PMV index value may be maintained in a required range.

In the process of performing the comfort power saving operation, whether the second set time has elapsed may be recognized (S34). When the second set time has elapsed, it may be determined whether the user (occupant) is present in the indoor space (S35). When the user is absent, subsequent steps or operations from step S32 may be performed. When the user is present, subsequent steps or operations from step S12 may be performed.

When the second set time has elapsed in S34, the air conditioner may be turned off (S37). That is, when the user does not return to the indoor space even through the comfort power saving operation is performed for a predetermined period of time in a state in which the set comfort temperature is set to the second temperature value B, which is relatively high, the comfort power saving operation may not be further performed, and the air conditioner may be turned off, thus reducing power consumption.

When the user does not return to the indoor space even through the second set time has elapsed, it may be considered to slightly increase the set comfort temperature and perform the comfort power saving operation. However, when the set comfort temperature is higher than the second temperature value B, it may be difficult to maintain the PMV index value in the required range (from −1 to +1). Accordingly, control may be performed focusing on reduction in power consumption by turning off the air conditioner.

When the user set temperature is higher than the second temperature value B in S31, the air conditioner may be turned off without performing the comfort power saving operation (S36 and S37). That is, in a case in which the temperature of the indoor space set by the user herself or himself is relatively high, when the set comfort temperature is determined to be equal to or higher than the user set temperature and operation is performed, maintaining the comfort degree of the indoor space may be limited. In this case, it is possible to turn off the air conditioner. Thereafter, although the user returns to the indoor space, the user may barely feel inconvenience with respect to the comfort degree in consideration of the user's preference.

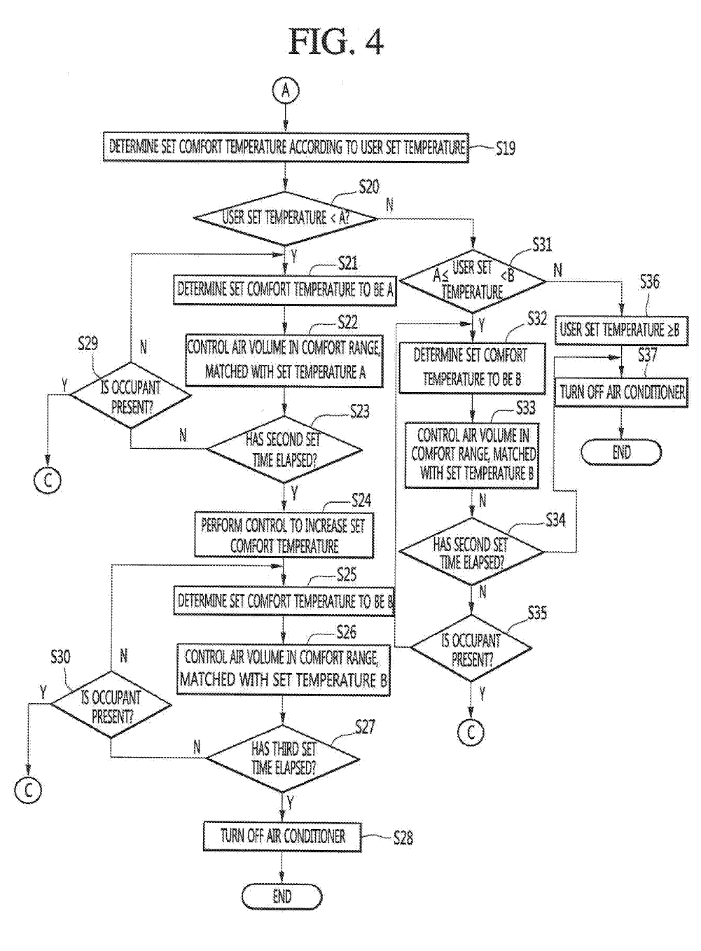

When it is determined that the air conditioner performs an air heating operation in S18, S40 to S59 may be performed. As content of S40 to S59 is similar to the content described with respect to S19 to S37 of FIG. 4, the description given with reference to FIG. 4 may be referred with respect to the common part. It is noted that the set comfort temperature may be determined differently due to a difference between the air cooling operation and the air heating operation.

When the operation mode of the air conditioner is the air heating operation, a set comfort temperature may be determined according to the “user set temperature” set by the user (S40). The set comfort temperature may be a predetermined temperature value in order to make it easy that a required comfort degree of the indoor space, that is, the PMV index value is in a range from −1 to +1 (S40).

More specifically, when the user set temperature is higher than a third temperature value C (S41), the set comfort temperature may be determined to be the third temperature value C (S42). That is, the set comfort temperature may be determined to be lower than the temperature set by the user. For example, the third set temperature C may be 28′C. In addition, an air volume in a comfort range, which is matched with the set comfort temperature C, may be controlled (S43).

Due to the above control, the indoor space may be controlled such that the required comfort degree, that is, the PMV index value is in the range from −1 to +1. For example, as a factor causing relatively large power consumption in the operation of the air conditioner is a set temperature, the PMV index value may be controlled so as to be a required value by maintaining the set temperature at the third temperature value C and controlling the air speed through control of the number of rotations of the Indoor fan.

In the process of controlling the comfort power saving operation, whether the second set time has elapsed may be recognized (S44). The second set time may be a time counted from a time when the first set time has elapsed, and may be, for example, about 20 minutes.

When the second set time has elapsed, control may be performed to increase the power saving level of the comfort power saving operation (S45). More specifically, it is possible to perform control to decrease the comfort set temperature. That is, it is possible to decrease the comfort power saving temperature from the third temperature value C to the fourth temperature value D (S46). The fourth temperature value D may be lower than the third temperature value C, and may be, for example, 26° C. In addition, an air volume in a comfort range, which is matched with the set comfort temperature D, may be controlled (S47).

In the process of performing control, the PMV index value may be controlled to be in a required range (−1 to +1), and therefore, the minimum comfort degree of the indoor space may be maintained. Further, as the power saving level higher than the power saving level of the power saving operation performed in S43 is maintained in S47, power consumption may be reduced.

Following the process of performing the control of S45 to S47, whether the third set time has elapsed may be determined (S48). The third set time may be a time counted from a time point when the second set time has elapsed, and may be, for example, about 10 minutes. When the third set time has elapsed, it may be determined that the user is absent for a long time, the operation of the air conditioner may be turned off (S49).

As described above, by advancing a time at which increasing the power saving level is performed in such a way that the second set time is determined to be shorter than the first set time and the third set time is determined to be shorter than the second set time, it is possible to prevent air conditioning from being performed unnecessarily excessively in the indoor space from which the user is absent. Accordingly, power consumption may be reduced.

On the other hand, when it is recognized that the second set time has not elapsed in S44, it may be determined whether the user (occupant) is present in the indoor space (S50). When the user is absent, subsequent steps or operations from S42 may be performed. When the user is present, subsequent steps or operations from S12 may be performed.

When it is recognized that the third set time has not elapsed in S48, it is determined whether the user (occupant) is present in the indoor space (S51). When the user is absent, subsequent steps or operations from S46 may be performed. When the user is present, subsequent steps or operations from S12 may be performed.

When the user set temperature is higher than the fourth temperature value D and lower than the third temperature value C in S52, the set comfort temperature may be determined to be the fourth temperature value D (S53). That is, in 842 and S46, determining the set comfort temperature to be the fourth temperature value D may be performed after the second set time has elapsed, whereas, in S52, determining the set comfort temperature to be the fourth temperature value D may be performed simultaneously with the initiation of the comfort power saving operation. The reason for this may be understood as a result of determination that the comfort degree of the indoor space is determined as being high or low depending on the preference of the user, that is, the user set temperature. In addition, an air volume in a comfort range, which is matched with the set comfort temperature D may be controlled (S54). By performing control as described above, the PMV index value may be maintained in a required range.

In the process of controlling the comfort power saving operation, whether the second set time has elapsed may be recognized (S55). When the second set time has elapsed, it may be determined whether the user (occupant) is present in the indoor space (S56). When the user is absent, subsequent steps or operations from S53 may be performed. When the user is present, subsequent steps or operations from S12 may be performed.

When the second set time has elapsed in S55, the air conditioner may be turned off (S58). That is, when the user does not enter the indoor space even through the comfort power saving operation is performed for a predetermined period of time in a state in which the set comfort temperature is set to the fourth temperature value D, which is relatively low, the comfort power saving operation may not be performed anymore, and the air conditioner may be turned off, thus reducing power consumption.

When the user does not return to the indoor space even through the second set time has elapsed, it may be considered to slightly decrease the set comfort temperature and perform the comfort power saving operation. However, when the set comfort temperature is lower than the fourth temperature value D, it may be difficult to maintain the PMV index value in the required range (from −1 to +1). Accordingly, control may be performed focusing on reduction in power consumption by turning off the air conditioner.

When the user set temperature is lower than the fourth temperature value D S57, the air conditioner may be turned off without performing the comfort power saving operation (S58). That is, in a case in which the temperature of the indoor space set by the user herself or himself is relatively low, when the set comfort temperature is determined to be equal to or lower than the user set temperature and operation is performed, maintaining the comfort degree of the indoor space may be limited. In this case, it is possible to turn off the air conditioner. Thereafter, although the user returns to the indoor space, the user may barely feel inconvenience with respect to the comfort degree in consideration of the user's preference.

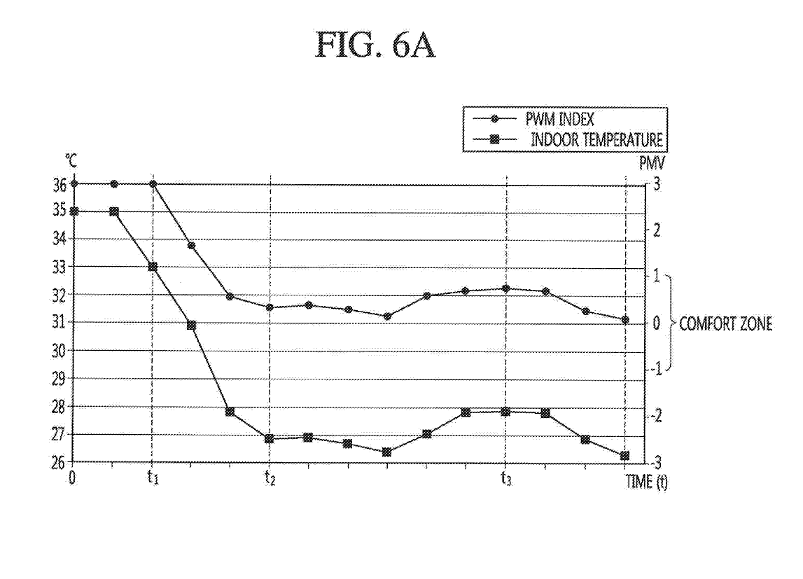

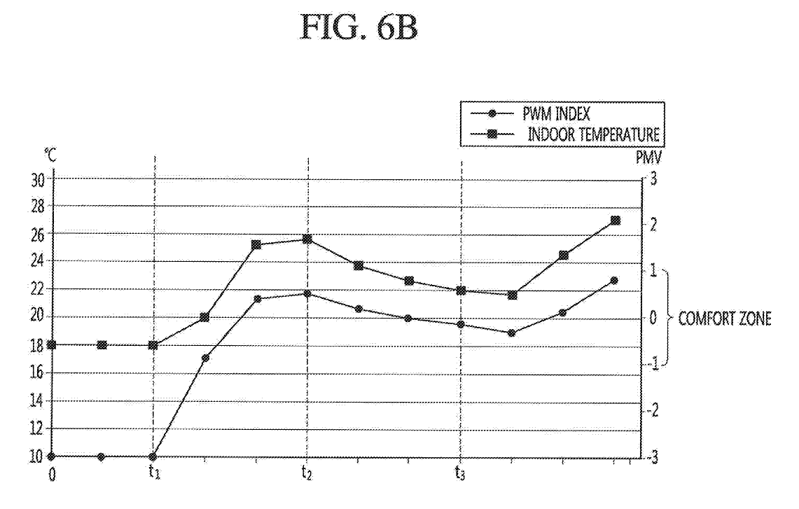

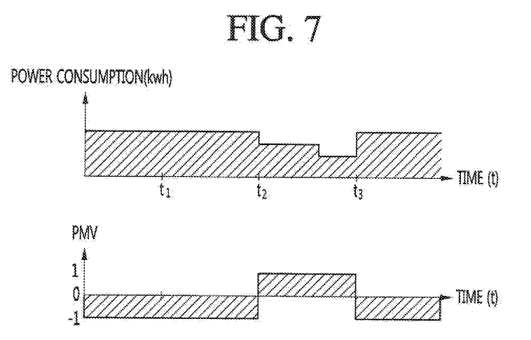

FIGS. 6A and 6B are graphs showing changes in temperature of an indoor space and PMV index in an air heating operation and an air cooling operation of an air conditioner. FIG. 7 is a graph showing changes in PMV index and power consumption in a case of controlling operation of an air conditioner according to an embodiment.

Referring to FIG. 6A, when operation of an air conditioner, such as air conditioner 1, is controlled according to the method described with reference to FIGS. 3 and 4, the PMV index value may be maintained in a required range, that is, a range of larger than −1 and smaller than +1 (hereinafter, referred to as a “comfort zone”). More specifically, when the air cooling operation is initiated after the power supply of the air conditioner is turned on, an indoor temperature gradually decreases based on the user set temperature and the PMV index value decreases toward the comfort zone.

It may be sensed whether the user is present in the indoor space. At time t₁, it may be sensed that the user is absent from the indoor space. A time may be counted from a time point when it is sensed that the user is absent. When a first set time has elapsed, that is, at time t₂, the comfort power saving operation may be performed. Therefore, the first set time, which is described with reference to FIGS. 3 to 5, may be a value (t₂−t₁).

Time t₃ may be a time point when the user returns to the indoor space and time t₃−t₂ may be a time during which the comfort power saving operation is performed. Although the user returns to the indoor space 30 at the time t₃, the PMV index value may be in the range of the comfort zone, and therefore, a comfort degree of the indoor space may be recognized as being fine. By performing control as described above, it is possible to maintain the comfort degree at a set level while reducing power consumption.

More specifically, referring to FIG. 7, when the comfort power saving operation is initiated at time t₂, the PMV index value may be maintained in the range of the comfort zone (smaller than +1) in spite of an increment in the PMV index value. Further, power consumption may be reduced.

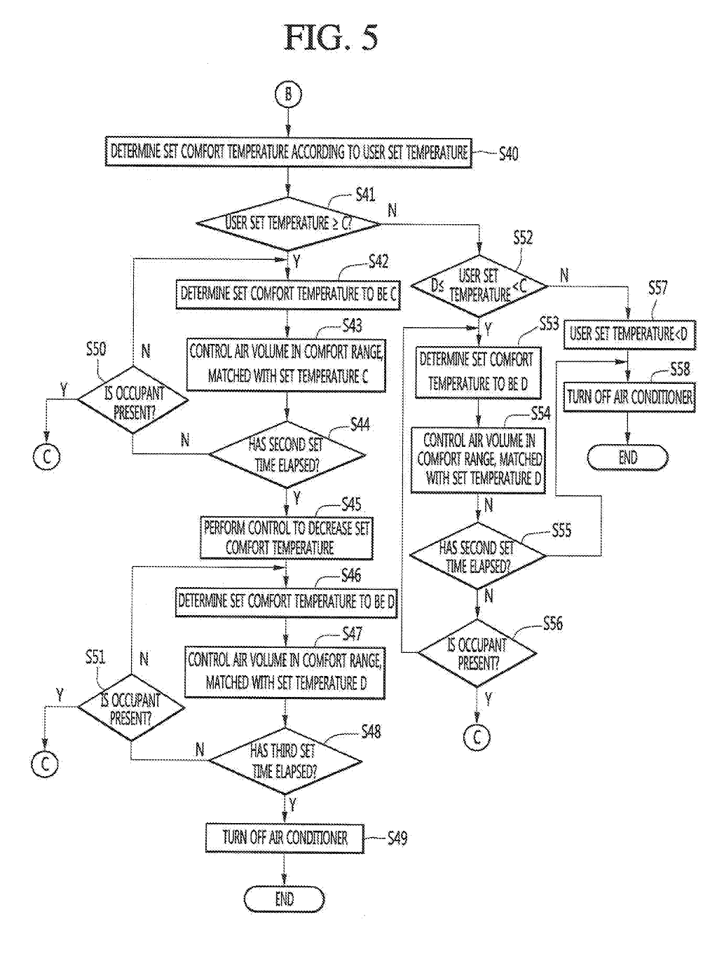

Referring to FIG. 6B, when the operation of the air conditioner is controlled according to the method described with reference to FIGS. 3 and 5, the PMV index value may be maintained in a required range, that is, a range of larger than −1 and smaller than +1 (hereinafter, referred to as a “comfort zone”). More specifically, when the air heating operation is initiated after the power supply of the air conditioner is turned on, the indoor temperature gradually increases based on the user set temperature and the PMV index value increases toward the comfort zone.

It may be sensed whether the user is present in the Indoor space. At time t₁, it may be sensed that the user is absent from the indoor space. Time may be counted from a time point when it is sensed that the user is absent. When a first set time has elapsed, that is, at time t₂, the comfort power saving operation may be performed.

Time t₃ may be a time when the user returns to the indoor space and time t₃−t₂ may be a time when the comfort power saving operation is performed. Although the user returns to the indoor space at time t₃, the PMV index value may be in the range of the comfort zone, and therefore, a comfort degree of the indoor space may be recognized as being fine. By performing control as described above, it is possible to maintain the comfort degree at a set level while reducing power consumption.

Although a separate graph is not illustrated as in FIG. 7, when the comfort power saving operation is initiated at time t₂, the PMV index value may be maintained in the range of the comfort zone (larger than −1) in spite of an increment in the PMV index value. Further, it is possible to reduce power consumption.

In order to solve the above-described problem, embodiments disclosed herein provide an air conditioner and a method for controlling an air conditioner, which can reduce energy consumption. Further, embodiments disclosed herein provide an air conditioner and a method for controlling an air conditioner, which can maintain a comfortable indoor space so as to allow a user to feel comfortable when entering an indoor space after the user has been absent for a while. Furthermore, embodiments disclosed herein provide an air conditioner and a method for controlling an air conditioner, which perform a power saving operation while implementing a relatively comfort indoor space even when a user comes in and goes out of an indoor space at irregular time intervals.

Embodiment disclosed herein provide a method for controlling an air conditioner that may include determining a user set temperature and performing an air cooling operation or an air heating operation in an indoor space; determining whether a user is present in the indoor space; when it is determined that a user is absent, counting an elapsed time; and when the elapsed time reaches a set time, performing a predetermined operation mode. The predetermined operation mode may include a comfort power saving mode, and the comfort power saving mode may include an operation controlled according to a set comfort temperature determined such that a predicted mean vote (PMV) determined based on temperature, humidity, air speed, mean radiant temperature, clothing insulation, and metabolic rate may be maintained in a preset or predetermined range.

The performing of the comfort power saving operation may include increasing a power saving level of the comfort power saving operation in a stepwise manner as time elapses. The increasing of the power saving level may include determining the set comfort temperature to increase in a stepwise manner as time elapses when the air conditioner performs the air cooling operation. The increasing of the power saving level may include determining the set comfort temperature to decrease in a stepwise manner as time elapses when the air conditioner performs the air heating operation.

The performing of the comfort power saving mode may include changing the set comfort temperature as a first step when a first set time has elapsed and changing the set comfort temperature as a second step when a second set time has elapsed from a time point when the first set time has elapsed. The second set time may be shorter than the first set time.

The performing of the comfort power saving mode may include turning off the air conditioner when a third set time has elapsed from a time point when the second set time has elapsed. The third set time may be shorter than the second set time. The set comfort temperature may be determined based on the user set temperature.

In a case where the air conditioner performs an air cooling operation, when the user set temperature is lower than a first temperature value (A), the set comfort temperature may be determined to be the first temperature value (A), and in a case where the air conditioner performs the comfort power saving operation, the set comfort temperature may be changed to a second temperature value (B) higher than the first temperature value (A) as time elapses. In a case where the air conditioner performs an air heating operation, when the user set temperature is higher than a third temperature value (C), the set comfort temperature may be determined to be the third temperature value (C), and in a case where the air conditioner performs the comfort power saving operation, the set comfort temperature may be changed to a fourth temperature value (D) lower than the third temperature value (C) as time elapses.

The temperature and the mean radiant temperature may be determined by a temperature sensor, the humidity may be determined by a humidity sensor, and the air speed may be determined by the number of rotations of an indoor fan of the air conditioner. The clothing insulation and the metabolic rate may be determined to be set values. The set comfort temperature may include a predetermined temperature value such that an index value of the PMV has a value in a range from −1 to +1.

Embodiments disclosed herein provide an air conditioner that may include an indoor unit or device mounted in an indoor space and having a suction portion or inlet and a discharge portion or outlet; an input unit or input configured to allow input of a user set temperature of the indoor space; a human sensing unit or sensor provided in or at one side of the indoor unit to sense whether an occupant is present in the indoor space; a timer configured to count an elapsed time when it is sensed by the human sensing unit that the occupant is absent; and a control unit or controller configured to determine a set comfort temperature having a different value from the user set temperature such that a predicted mean vote (PMV) may be maintained in a set range when the elapsed time counted by the timer reaches a set time.

The air conditioner may further include a memory unit or memory configured to store predetermined information about clothing insulation and metabolic rate from among factors determining the PMV. The memory unit may further store reference image information capable of being compared with an image acquired by the human body sensing unit.

The air conditioner may further include, from among factors determining the PMV, a temperature sensor configured to determine a temperature; a humidity sensor configured to determine a humidity; and an indoor fan, a number of rotations of which may be sensed to determine an air speed. The control unit may control an operation of the air conditioner to increase a power saving level by changing the set comfort temperature in a stepwise manner as time elapses.

According to embodiments disclosed herein, it is possible to sense whether a user is present in an indoor space and perform a power saving operation of an air conditioner according to a sensing result, thus preventing unnecessary energy consumption. Also, as a range of the power saving operation may be determined such that a comfort degree of the Indoor space may be maintained at a predetermined level, during the power saving operation of the air conditioner, it is possible to prevent the user from feeling uncomfortable when entering the indoor space.

Further, it is possible to prevent unnecessary energy consumption due to the absence of the user for a long time by increasing a power saving level in a stepwise manner when the user is continuously absent. In particular, it is possible to prevent unnecessary energy consumption by reducing a time interval at which the power saving level is increased in a stepwise manner.

Also, when a set indoor temperature of the user is out of a range of a comfort degree of the indoor space, or the user is absent for a very long time, it is possible to prevent unnecessary energy consumption by turning off the power supply of the air conditioner. In addition, as the comfort degree of the indoor space may be controlled by a predicted mean vote index, the comfort degree of the user may be efficiently maintained.

Further, as the human body sensor, for example, a vision sensor or a pyroelectric infrared (PIR) sensor may be mounted in the indoor unit, it is possible to easily sense whether an object in the indoor space is a person or an object.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for controlling an air conditioner, the method comprising:
determining a user set temperature and performing an air cooling operation or an air heating operation in an indoor space;
determining whether a user is present in the indoor space;
when it is determined that the user is absent from the indoor space, counting an elapsed time; and
when the elapsed time reaches a set time, performing a predetermined operation mode.

2. The method of claim 1, wherein the performing of the predetermined operation mode includes performing a comfort power saving mode, and the comfort power saving mode includes an operation controlled according to a set comfort temperature determined such that a predicted mean vote (PMV) determined based on temperature, humidity, air speed, mean radiant temperature, clothing insulation, and metabolic rate is maintained in a preset range.

3. The method of claim 1, wherein the performing of the comfort power saving mode includes increasing a power saving level of the comfort power saving mode in a stepwise manner as time elapses.

4. The method of claim 3, wherein the increasing of the power saving level includes increasing the set comfort temperature in a stepwise manner as time elapses when the air conditioner performs the air cooling operation.

5. The method of claim 3, wherein the increasing of the power saving level includes decreasing the set comfort temperature in a stepwise manner as time elapses when the air conditioner performs the air heating operation.

6. The method of claim 3, wherein the performing of the comfort power saving mode includes changing the set comfort temperature as a first step when a first set time has elapsed and changing the set comfort temperature as a second step when a second set time has elapsed from a time point at which the first set time has elapsed.

7. The method of claim 6, wherein the second set time is less than the first set time.

8. The method of claim 7, wherein the performing of the comfort power saving mode includes turning off the air conditioner when a third set time has elapsed from a time point at which the second set time has elapsed.

9. The method of claim 8, wherein the third set time is less than the second set time.

10. The method of claim 1, wherein the set comfort temperature is determined based on the user set temperature.

11. The method of claim 10, wherein, in a case in which the air conditioner performs the air cooling operation, when the user set temperature is lower than a first temperature value, the set comfort temperature is determined to be the first temperature value, and in a case in which the air conditioner performs the comfort power saving operation, the set comfort temperature is changed to a second temperature value higher than the first temperature value as time elapses.

12. The method of claim 10, wherein, in a case in which the air conditioner performs the air heating operation, when the user set temperature is higher than a first temperature value, the set comfort temperature is determined to be the first temperature value, and in a case in which the air conditioner performs the comfort power saving operation, the set comfort temperature is changed to a second temperature value lower than the first temperature value as time elapses.

13. The method of claim 2, wherein a temperature and a mean radiant temperature are determined by a temperature sensor, a humidity is determined by a humidity sensor, and an air speed is determined by a number of rotations of an indoor fan of the air conditioner.

14. The method of claim 13, wherein a clothing insulation and a metabolic rate are determined to be set values.

15. The method of claim 2, wherein the set comfort temperature includes a predetermined temperature value such that an index value of the PMV has a value in a range from −1 to +1.

16. An air conditioner, comprising:
an indoor device mounted in an indoor space and having a suction inlet and one or more discharge outlet;
an input configured to receive input of a user set temperature of the indoor space;
a human sensor provided on or at one side of the indoor device to sense whether an occupant is present in the indoor space;
a timer configured to count an elapsed time from when it is sensed by the human sensor that the occupant is absent from the indoor space; and
a controller configured to determine a set comfort temperature having a different value from the user set temperature such that a predicted mean vote (PMV) is maintained in a set range when the elapsed time counted by the timer reaches a set time.

17. The air conditioner of claim 18, further including a memory configured to store predetermined information about clothing insulation and metabolic rate from among factors determining the PMV.

18. The air conditioner of claim 17, wherein the memory further stores reference image information capable of being compared with an image acquired by the human body sensor.

19. The air conditioner of claim 16, further including:
a temperature sensor configured to determine a temperature from among factors determining the PMV;
a humidity sensor configured to determine a humidity from among the factors determining the PMV; and
an indoor fan, a number of rotations of which is sensed to determine an air speed from among the factors determining the PMV.

20. The air conditioner of claim 16, wherein the controller controls an operation of the air conditioner to increase a power saving level by changing the set comfort temperature in a stepwise manner as time elapses.

21. A method for controlling an air conditioner, the method comprising:
determining a user set temperature and performing an air cooling operation or an air heating operation in an indoor space;
determining whether a user is present in the indoor space;
when it is determined that the user is absent from the indoor space, counting an elapsed time; and
when the elapsed time reaches a set time, performing a comfort power saving mode, wherein the performing of the comfort power saving mode includes increasing a power saving level of the comfort power saving mode in a stepwise manner as time elapses.

22. The method of claim 21, wherein the performing of the comfort power saving mode includes changing the set comfort temperature as a first step when a first set time has elapsed and changing the set comfort temperature as a second step when a second set time has elapsed from a time point at which the first set time has elapsed, and wherein the second set time is less than the first set time.

23. The method of claim 22, wherein the performing of the comfort power saving mode includes turning off the air conditioner when a third set time has elapsed from a time point at which the second set time has elapsed, and wherein the third set time is less than the second set time.

24. The method of claim 21, wherein the set comfort temperature includes a predetermined temperature value such that an index value of a predicted mean vote (PMV) determined based on temperature, humidity, air speed, mean radiant temperature, clothing insulation, and metabolic rate has a value within a predetermined range.

25. The method of claim 24, wherein the predetermined range is from −1 to +1
